(19) United States
(12) Patent Application Publication
(10) Pub. No.: US 2014/0290791 A1
(43) Pub. Date: Oct. 2, 2014

(54) MOBILE FILLING STATION

(71) Applicants: WENDELL W. ISOM, Grand Island, NY (US); Marcelo Ribeiro, East Amherst, NY (US); Armando Alejandro Garcia, Cuautitlan Izcall (MX)

(72) Inventors: WENDELL W. ISOM, Grand Island, NY (US); Marcelo Ribeiro, East Amherst, NY (US); Armando Alejandro Garcia, Cuautitlan Izcall (MX)

(21) Appl. No.: 14/305,634

(22) Filed: Jun. 16, 2014

Related U.S. Application Data
(63) Continuation of application No. 13/746,020, filed on Jan. 21, 2013.

(51) Int. Cl. F17C 5/06

(52) U.S. Cl. CPC F17C 5/06
USPC 141/4; 29/407.1

(57) ABSTRACT

The present invention relates generally to a compact, mobile filling station for fitting cylinders. The compact modular filling station is capable of filling cylinders with fluids at high pressures and at high gas flow rates to achieve a rapid fill rates as measured in volume of fluid per time per filling system area using a controlled temperature filling process.

### CROSS-REFERENCE TO RELATED APPLICATION

This application is a continuation of pending U.S. patent application Ser. No. 13/746,020 filed Jan. 21, 2013 which claims the benefit of U.S. provisional application No. 60/600,851, filed Feb. 20, 2012, the disclosure of which is incorporated by reference herein.

### FIELD OF THE INVENTION

The present invention relates generally to a mobile filling station designed for deployment to remote sites and which is capable of fast filling containers with pressurized liquid or gas fluids, preferably cryogenic liquids or gases. In one aspect the invention relates to a compact, mobile filling station, and in another aspect it relates to the fast filling of cylinders with cryogenic fluids at high pressures without encountering high heat of compression problems during the filling operation.

### BACKGROUND OF THE INVENTION

Gas and liquid products used in various commercial and medical applications are often received, stored, and dispensed through containers of various sizes generally referred to as cylinders. There are numerous type of cylinders each having unique requirements or specifications for holding fluid products such as oxygen, nitrogen, argon, helium, methane, hydrogen, acetylene, natural gas, and mixtures thereof at various pressures and under various conditions.

Containers of such gases and liquids, referred to herein collectively as cylinders, are typically tilled at permanent cylinder filling sites and transported to industrial sites for usage. Once used and emptied, the cylinders are collected and replaced with new cylinders through various transportation/delivery operations. The used or emptied cylinders are returned to a central and permanent filling facility for refilling. The filling facilities are generally installed, operated, and maintained by industrial gas suppliers who transport filled containers to the point of use. To reduce transportation costs and complex logistics and to provide rapid and consistent supply of cylinders at the point of use, remote filling stations, with rapid filling capability, are needed that can be deployed near or at the site of the end user.

The mobile filling station of this invention can be placed at remote locations such as end user's sites and is capable of rapid deployment for the rapid and efficient filling of as and liquid products into a wide range of cylinder types. The mobile filling station contains all necessary filling process equipment mounted on a mobile platform or skid which can be easily moved to the desired location and can perform the operation of filling high pressure cylinders with pure and/or mixtures of products. Such filling equipment include, but are not limited to, piping and valve assemblies, pressure gauges, pressure transmitters, pressure switches, pressure relief devices, vaporizers (for gases), liquid pumps (for liquids used at elevated pressure), vacuum pumps, and mixing and filling control systems. Bulk storage tanks are used to store the fluids to be filled. The mobile filling station can be shop fabricated and transported by truck, rail, or sea to the remote site thereby minimizing field construction and labor costs. It offers timely and reliable product supply to the user at reduced costs.

The compact mobile filling station has a small area footprint, and has a high capacity to rapidly fill multiple cylinders using at least one filling bay, each bay incorporating an individual filling system. The station employs a filling process that ensures complete fitting of cylinders. The preferred filling station utilizes two modular fill bays (systems) to obtain a highly efficient filling process. Each fining bay is capable of serving multiple pallets and or bundles and each pallet or bundle has multiple cylinders. As a result, the compact design has the capacity for filling multiple cylinders at high pressures and at high flow rates on a minimum area footprint as measured in average volume of fluid per time per filling station area.

In another aspect of this invention, excessive cylinder temperatures caused by the heat of gas compression effects that occur during fast filling of cryogenic fluids are avoided by using a tow temperature control system. Generally, the pressure within the cylinder increases during the tilling process as the fluid, typically a gas, flows from the storage vessel into the cylinder. Depending on the pressure and/or the flow rate of the gas passed into the cylinder, heat of gas compression could exceed the heat dissipation rate from the cylinder wails to the environment. This will cause the temperature of the fluid within the cylinder to rise and reduce the amount of fluid capable of being put into the cylinder. Thus, it is preferred that the temperature of the gas within the cylinder be not more than ambient, about 120° F. (48° C.), since partially filled cylinders result in less gas delivered to the use point. To address this problem, this invention employs a filling system having a temperature control system designed to fill cylinders with one or more gases to a high pressure at high rates without encountering a heat buildup problem described above.

### BRIEF SUMMARY OF THE INVENTION

In one aspect of this invention, a mobile filling station is provided for efficient and rapid deployment to remote sites and which is capable of fast tilling containers with pressurized liquid or gas fluids, preferably cryogenic liquids or gases. The mobile filling station is economically designed to minimize the overall system area (footprint) and be easily deployed on a predesigned skid having all necessary filling equipment mounted thereon. The containers are filled with either a high purity gas or liquid or with a mixture of fluids (e.g. a mixture of gases or liquids) at high pressures and at high gas flow rates achieving rapid fill rates as measured in volume of fluid per volume per time per tilting system area. The modular design of the mobile station provides versatility and flexibility by accommodating any size, number, or type of containers used in single or multiple clusters and/or pallets.

In another aspect of the invention, excessive cylinder temperatures caused by the heat of gas compression effects that occur during fast filling of cryogenic fluids are avoided by using a temperature control process, such as a fuzzy temperature control process, within the filling process.

Accordingly, to one aspect of the present invention, a mobile modularized tilling station for titling cylinders with fluids is provided comprising:

a portable skid containing at least two filling systems designed to fill cylinders affixed thereto,

the filling system comprising filling equipment in fluid communication with a fluid source and cylinders to he filled and capable of pressurizing and filling the cylinders with fluid at fast flow rates, and

wherein the physical configuration of the filling equipment is in close approximation such that the tilling station has a capacity to fill cylinders at an average rate of at least 80 scfh per sq. foot of skid.

In another aspect of this invention, a process for tilling a cylinder with cryogenic gas is provided comprising:

pumping a cryogenic liquid at a initial rate to an elevated pressure within the range of from 800 to 10,000 psia to produce elevated pressure cryogenic liquid;

vaporizing a first portion of the elevated pressure cryogenic liquid to produce elevated pressure gas;

mixing a second portion of the elevated pressure cryogenic liquid with the elevated pressure gas and vaporizing the second portion of the elevated pressure cryogenic liquid by direct heat exchange with the elevated pressure gas to produce a controlled temperature elevated pressure gas having a temperature of higher than −40° F. (−40° C.);

passing the controlled temperature elevated pressure gas into the cylinder to form a filled gas; and

varying the cryogenic liquid pumping initial rate based on the temperature rise to limit the temperature of filled gas to not more than 120° F. (48° C.).

### BRIEF DESCRIPTION OF THE DRAWINGS

FIG. 1 shows a 3-dimensional view of a mobile filling system according to present invention for filling cylinders with a pure gas,

FIGS. 2(a) and 2(b) show schematic representations of particularly preferred embodiments of the invention for providing cylinders containing pure gas (oxygen) and a gas mixture (argon and carbon dioxide), respectively.

FIGS. 3(a) and 3(b) are top views of the fill layout of the embodiments shown in FIGS. 2(a) and 2(b).

### DETAILED DESCRIPTION OF THE INVENTION

The mobile filling station of this invention is designed to fit on a small area foot print and is assembled primarily at a central location or shop for deployment to remote locations. It is designed for the fast filling of containers with pressurized liquid or gas fluids, preferably cryogenic fluids, and has a compact modular configuration. The filling station has two filling systems affixed thereto capable of rapidly pressurizing and filling cylinders. Each filling system is comprised of conventional filling equipment in a compact physical configuration to maximize the fill rate capacity as measured by volume of fluid per time per filling system area.

The filling station is modular, sits on a single reinforced skid with optional self propelled hydraulic lifts for raising skid onto flat bed for transport, can be transported by standard sized truck or rail, and can be fully operational with minimum construction at the use site. The skid is typically made from a welded tubular steel structure with all major pieces of equipment bolted or otherwise affixed to the floor of the skid using conventional fixtures such as bolts or screws on a suitable shock absorber. The shock absorber is selected to reduce damage to the equipment during transportation. An example of suitable shock absorbers include, but are not limited to, solid rubber blocks or metal springs sized for skid load on a rod and pinion assembly. Other materials can be selected based on their strength and durability.

The mobile filling station is designed to be shipped to the final location of use, connected to a source of fluid to be filled, typically in the form of a storage tank and used to fill high purity industrial or medical fluids, preferably gases or mixtures of gases. It is designed to optimally fill a large number of cylinders for a prolong time with minimum labor.

Each mobile filling system is a self contained autonomous system with a dedicated control system comprising a programmable logic controller (PLC), historian server and touch screen human machine interface (IMO enabling both automatic and manual operation and capable of filling differing sized cylinders with different fluid products. The preferred mobile filling station is designed for two filling systems which can fill two cylinder pallets or clusters of cylinders and which may share the PLC and server. The geometric design of the station provides a modular “plug and operate” capability for handling multiple till system configurations.

Any suitable fluid in gases or liquid state can be employed. Examples of suitable cryogenic liquids which can be used in the practice of this invention include oxygen, nitrogen, argon, helium, carbon dioxide, hydrogen, methane, natural gas and mixtures of two or more thereof. Atmospheric or electric vaporizers or combinations may be located on the skid for maximum efficiency and ease of maintenance and all filling equipment is designed to use minimum space. In addition, the filling equipment is configured in as close approximation as possible.

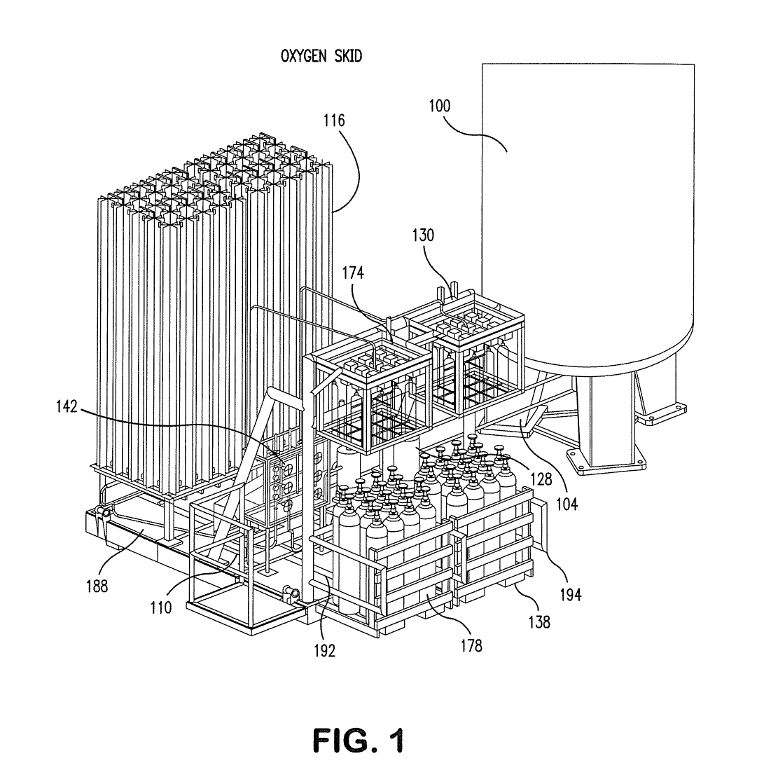

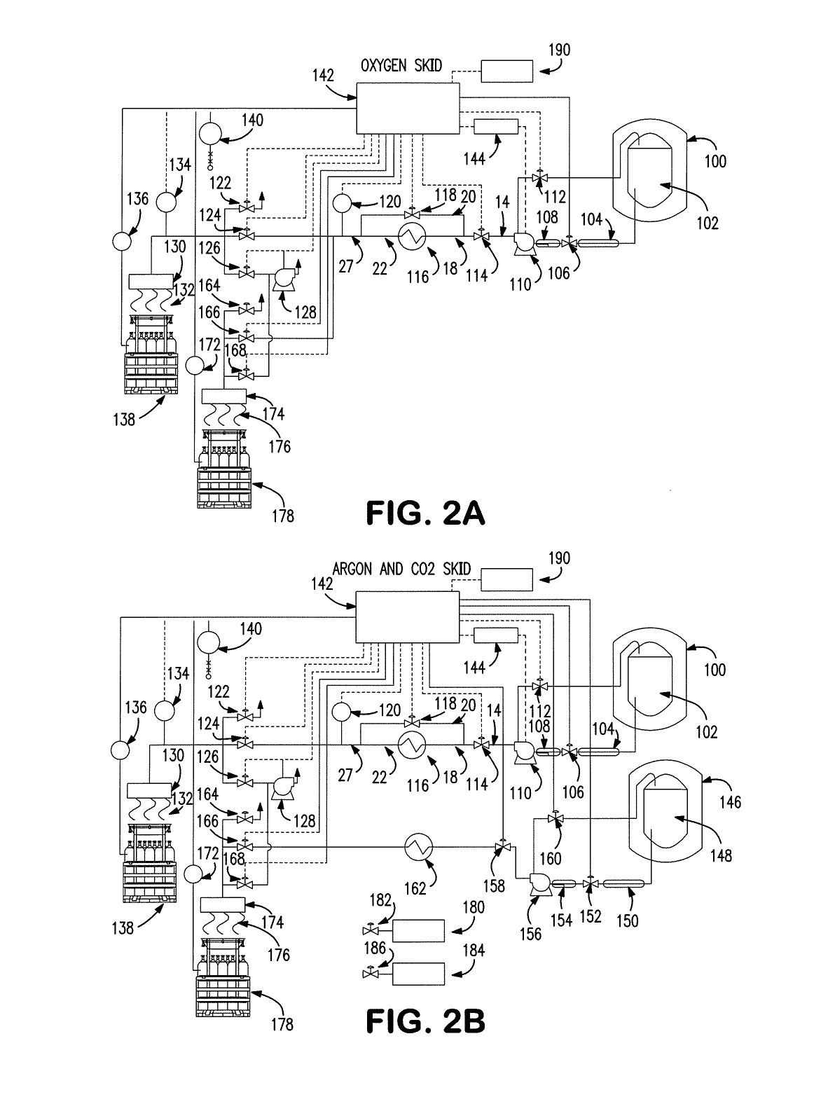

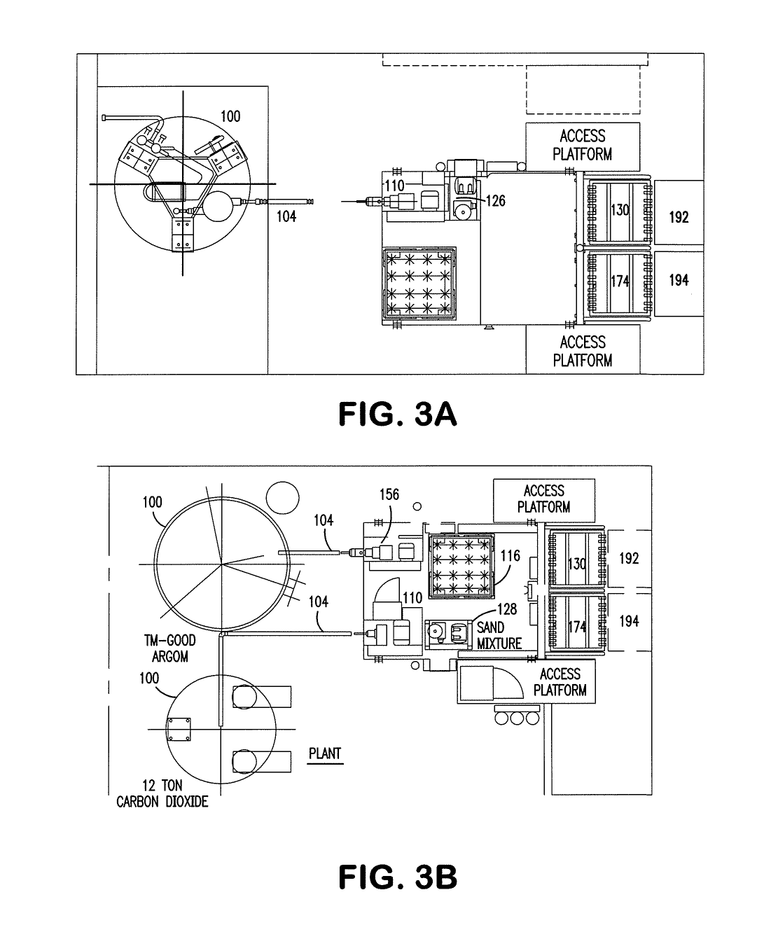

The invention will be described in detail for a preferred cryogenic liquid filling system, but should not be construed as being limited to cryogenic fluids and includes filling systems for all types of fluids. FIG. 1 is a three dimensional view of the mobile filling station to provide overall context. FIGS. 2A and 3A are schematic representations of an oxygen filling system and FIGS. 2B and 3B are schematic representations of a typical argon and carbon dioxide mixture filling system.

With reference to FIG. 11, a suitably sized storage tank 100 is placed adjacent o a mobile filling station skid 188 and is sized and installed to supply adequate fluid for the filling process. Typically, the tanks range from 1500 to 13000 gallons and standard sized tanks can be employed. Skid 188 will have the following filling equipment for filling a single fluid such as oxygen and is connected as shown and as understood by one skilled in the art:
cryogenic reciprocating pump 110 connected to tank 100 using piping 104 and 108, preferably vacuum insulated, with suction valve 106, return valve 112 and discharge valve 114;
vaporizer 116;
vacuum pump 128;
fill bays 192 and 194, each adapted to receive standard pallets or clusters 178 and 138, respectively, holding a multiplicity of cylinders (for example 12, 16 or 20 cylinders per palletcluster);
fill heads, also referred to as filling manifolds, 130 and 174 comprising a network of piping and valves for venting, evacuating and filling cylinders; and
control panel 142 containing a programmable logic control (PLC) system, Historian server for data collections and storage, human machine interface (ILA) 190, and optional analyzers depending on the fluid or mixture being filled.

For filling gas mixtures, skid 188 will have pumps 110 and 156, and vaporizers 116 and 162 for each fluid, as well as, vacuum pump 128, venting means 122, 166 and evacuating means for each fluid fill line in a preferred embodiment, skid 188 occupies a foot print of not more than about 72 ft² (6.6 m²) based on a design of approximately 8 feet wide by 9 feet long (2.4 meters wide by 2.7 meters long), and the entire station comprising the storage tank 100, skid 188, and temporary storage area 192, 194 for palletsclusters prior to loading onto fill bays 178 and 138, will occupy a foot print of preferably not more than 344 ft² (36 approximately 4 meters wide by 9 meters long. The mobile filling station has a capacity for filling at least 3,000 “T” size cylinders per month in one 8 hour shift using one employee, or at least 7,000 cylinders per month in two 8 hour per day shifts using two employees.

Referring now to FIGS. 2A, 2B, and 3A, 3B, tank 100 is generally a standard™ tank or Siphon tank although any suitably sized fluid source can be employed which preferably permits the filling system to continuously operate for at least 22 business days per month with two 8 hour shifts. Tank 100 is located within 9 feet (3 meters), and preferably from about 5.5 feet to 7.5 feet (1.7 to 2.3 meters), of skid 188 to minimize area requirements. Atmospheric vaporizer units 116, 162, preferably of compact configuration, are installed on skid 188 such that the distance between the vaporizer 116 and the cryogenic pumps 110, 156 and between the vaporizers 116, 162 and the fill heads 130 and 174 is minimized. The piping path is designed to provide for a flow based upon lengths between vaporizer 116 and cryogenic pumps 110, 156 and between vaporizer 116 and fill heads 130 and 174 of less than 9 feet (3 meters) each and preferably less than 6 feet (2 meters) each, respectively when using a fill pipe diameter of ¾ inch (1.9 cm) for the capacity described. The shortest path length piping for pipe diameters of 2.5 inch (6.4 cm) is utilized to connect fill heads 134 and 174 to vacuum pump 128 for fast evacuation rates with a typical piping distance between the vacuum pump 128 and the fill heads 130 and 174 is three feet (one meter) or less. The pipe lengths are selected for maximum efficiency of flow, size, and temperature control. Skid 188 will also contain analyzers 180 and 184 and associated flow limiting valves 182 and 186 for measuring carbon dioxide and argon concentrations when filling argon and carbon dioxide mixtures (or other gas mixtures) and/or moisture levels and to automatically verify the required purity levels for the end user utilization.

The embodiment of the invention illustrated in FIG. 2(a) shows cylinders on pallet 138, ready for filling and connected by charging lines 132 to fill head 130. Also shown are cylinders on pallet 178 connected by charging lines 176 to fill head 174. In one mode of operation, the station has two bays and is using each filling system to fill cylinders on each pallet simultaneously. In another mode of operation, cylinders on one pallet are being filled, while the cylinders on the other pallet are being connected to their respective fill heads 124, 166, venting means 122, 166, and evacuated by vacuum pump 128. After the first pallet of cylinders is filled, gas flow to these cylinders is stopped by closing the appropriate valves, and gas flow into the second pallet of cylinders can be started by opening the appropriate valves. While the second pallet of cylinders is being filled, the filled cylinders of the first pallet are disconnected and readied for shipment to the use point, and empty cylinders are then connected to the manifold to start a new filling cycle. The procedure is repeated until all cylinders are filled. Analyzers 180, 184 are used as needed for quality control (QA) to automatically verify and guarantee the required purity levels for the customer utilization,

Cryogenic liquid is withdrawn from cryogenic liquid storage tank 100 through line 104 (shown with an optional insulation wrap) and valve 106, to line 108 and pumped to an elevated pressure, generally within the range of from 800 to 10000 psia, preferably from 1000 to 3500 psia, using cryogenic liquid pump 110 connected to the variable frequency drive (VFD) 144. The elevated pressure cryogenic liquid 14 passes from cryogenic liquid pump 110 and is divided into a first portion 18 and a second portion 20. The first portion 18 is fed to a vaporizer 116, and the second portion 20 bypasses the vaporizer 116.

Vaporizer 116 has an inlet which communicates with cryogenic liquid pump 110 whereby cryogenic liquid 14 moves from cryogenic liquid pump 110 into vaporizer 116, whereby the cryogenic liquid is vaporized to produce elevated pressure gas 22. Elevated pressure gas 22 exits from vaporizer 116. Any suitable vaporizer, such as a steam heated or electrically heated vaporizer may be used in the practice of this invention.

The second portion 20 of the elevated pressure cryogenic liquid bypasses vaporizer 116. Bypass valve 118 has a first passage which communicates with the vaporizer inlet whereby second portion 20 is passed to bypass valve 118, and has a second passage whereby the second portion of the cryogenic liquid from stream 14 passes from bypass valve 118 to the vaporizer outlet to mix with the elevated pressure gas 22. Heat from the elevated pressure gas 22 vaporizes the second portion of the elevated pressure cryogenic liquid by direct heat exchange thus producing controlled temperature elevated pressure gas 27 which is provided at the desired temperature for rapidly fining the cylinders. The temperature of the controlled temperature elevated pressure gas 27 should be higher than −40° F. (−40 ° C.), preferably within the range of −31° F. to 14° F. (−35° C. to −10° C.), and most preferably within the range of −31° F. to −22° F. (−35° C. to −30° C.). The temperature of the controlled temperature elevated pressure gas 27 is maintained within the desired range using temperature control system by manipulating bypass valve 118 to be in a more open or more closed position thus varying the second portion 20 of elevated pressure cryogenic liquid 14. The controlled temperature elevated pressure gas 27 is then filled into the cylinders through fill manifold 130. A combination of the liquid bypass valve 118, cryogenic liquid pump 110 variable frequency drive (VPD) 144, gas temperature sensing means 120, 136, 172 and those not shown (such as at the outlet of vaporizer and at inlet to fill heads 132 and 174) coordinated under a dedicated control scheme is used to obtain the temperature control. The VFD and valves will be controlled by an automated control system based on a predetermined algorithm such as a fuzzy logic algorithm.

For example, initially the cryogenic pump will be operated at a fixed pre-set speed to achieve an initial rate corresponding to pressure rise of 200 to 1000 psi/minute within the cylinder. During this phase the temperature control system will manipulate the bypass valve to maintain temperature measured by sensing means 120 or 136 or 172 within the desired range with reference to the total volume filled. As the cylinder filling proceeds, heat of gas compression may exceed the heat dissipation rate from the cylinder walls to the environment which results in a temperature rise of the filled gas or of the cylinder wall. When this happens, the temperature control system, using the sensing means to obtain a direct or indirect measurement of the temperature rise, will manipulate the VFD to vary the cryogenic liquid pumping rate to maintain temperature of filled gas within the desired range. Thus, when the temperature rises above ambient, the temperature control system reduces the pumping rate, reducing the fill rate and thereby maintaining the filled gas temperature to below ambient (120° F.). The temperature control system will save 10-20 minutes in a 50 minute tilling cycle as compared to a conventional slow rate filling process previously required to compensate for the gas heat of compression.

Because of the controlled low temperature of the gas being passe the cylinders, the gas may be passed into the cylinders at a very high rate, achieving rate of change of pressure within cylinder as high as 200 to 1000 psi per minute, which is two or more times faster than is possible with conventional practice without encountering super ambient temperatures within the cylinder. Typically the final pressure of the gas contents of the filled cylinders is within the range of from 1000 to 3500 psia and the temperature is within the range of 59° F. to 120° F. (15° C. to 48° C.), i.e. about ambient temperature. Thus, cylinder fining takes only about half as long with the practice of the invention as with conventional practice. When the cylinder(s) are filled, they are disconnected from the manifold arrangement and readied for shipment to the use point as was previously described.

The cylinder filling system of this invention enables a further enhancement to ensure rapid filling of cylinders with high pressure high purity gas or gas mixture. The shortest path length piping is utilized as charging lines to connect the fill head to the cylinders as described above. A pipe diameter of 2.5 inches (6.4 cm) or more is preferably utilized for connecting till heads 130 and 174 to vacuum pump 128 and to the venting means to facilitate cylinders venting and fast evacuation. Vacuum valve 126 is sized to have minimum flow area opening with equivalent hydraulic diameter in the range of 10% to 60% of that of the cylinder neck bore. In this way, flow resistance and volume to be evacuated is minimized to achieve fast evacuation rates, as well as desired sub ambient pressure prior to start of filling operation to assure compliance with high purity specifications.

Now by the use of the cryogenic fluid cylinder filling system of this invention wherein pressurized gas for cylinder filling is produced in a step which simultaneously controls the temperature of the gas to be at a defined low temperature prior to the gas being charged into the product cylinder, and the cylinder and associated piping are rapidly evacuated to a defined sub ambient pressure to make it ready for filling, the cylinder charging operation can proceed at a much faster pace than was heretofore possible, increasing the efficiency and lowering the costs of the cylinder filling procedure.

Referring again to FIG. 2(b), this system contains argon and carbon dioxide sources placed adjacent to the skid 188, which now contains cryogenic liquid pumps 110 and 156 for argon and carbon dioxide, and vaporizers 116 and 162 for each to produce desired temperature, pressure, and purity mixture. FIG. 3(a) is a top view of the mobile filling system corresponding to FIG. 2(a) for charging high pressure, high purity gas into one or more pallet of cylinders. FIG. 3(b) is a top view of the mobile filling system corresponding to FIG. 2(b) for charging high pressure gas mixture into two pallets of cylinders at fill bays 192 and 194, respectively. In a preferred embodiment, the skid in the system of FIG. 3(b) has the same dimension as the skid of FIG. 3(a) of 8 foot wide by 9 foot long (2.4 m×2.7 m). The mobile filling stations shown in FIGS. 2B and 3B have more equipment than the system filling pure gas shown in FIGS. 2A and 3A. The skid foot print is maintained constant by laying out process equipment differently.

The configuration of the filling system equipment on the skid is designed to maximize the fluid flow rates allowing for a fast fill rate as measured in volume of fluid per time per filling system area. By standardizing the equipment size, location and distance, optimizing the flow systems, and utilizing the temperature control system, the present filling station can fill cylinders at high flow rates per sq. foot of skid.

As one example, the mobile filling station having two filling bays/systems can be used to fill oxygen cylinders on 150 pallets containing 20 standard“T” sized cylinders/pallet in a month while operating eight hours/day for 22 business days. A standard “T” sized oxygen cylinder has a volume of 337 ft³(9.5 m³)). The preferred mobile filling station containing two fill bays will have a footprint area of 72 ft² (6.6 m²). yielding an average fill rate of 80 scfh/ft² (25 m³/hr/m²). This preferred mobile filling station when operated for 16 hours/day for 22 business days will fill 350 pallets, yielding an average fill rate of 93 scfh/ft² (29 m³/hr/m²).

As another example, the preferred mobile filling station can be used to fill a welding gas mixture containing a 75% argon/25% CO₂. The standard “T” sized welding gas mixture cylinder has a volume of 38 lft³(10.8 m³)). The preferred mobile filling station with two bayssystems and when operated for 22 business days/month can fill 150 pallets containing 20 standard “T” sized cylinderspallet in a month while operating eight hoursday or 350 pallets while operating 16 hoursday. In this case the mobile filling station yields an average fill rate of the welding gas mixture in the range of 90 scfh/ft² (28 m³hr/m²) to 105 scfh/ft² (33 m³/hr/m²).

The steps involved in filling cylinders using the mobile filling stations include (a) loading of pallet on the fill bay, (b) connecting cylinders to the fill head, (c) venting and evacuating cylinders and associated volume between cylinders and fill head, (d) purging as needed, (e) filling cylinders, (f) disconnecting filled cylinders, and (g) unloading pallet from fill bay. The typical times for venting is 2 minutes, vacuum is 3.5 minutes, purging is 4 minutes and filling is less than 50 minutes, preferably 12 to 20 minutes.

The filling operation begins when the operator loads a pallet of cylinders onto fill bays 138 or 178 and connects the cylinders to fill manifolds 130 or 174 via the charging lines (pigtails) 132 and 176. The operator will log-onto HMI 190 of the control panel 142 containing the control system, such as a fuzzy logic control system with predetermined pressure, temperature, and cylinder volume variables, and will make a selection between the automatic filling or manual filling mode. In the automatic filling mode the control system will start the sequence by downloading a predefined filling recipe such as the type of component gas and target fill pressure set points, then aligns the associated equipment required (pumps, control valves, VFD's etc.,) in accordance with a predetermined product recipe. Preferably, all process results including analytical filling data are tabulated and stored for on a local server which can be interrogated remotely.

For example, a pure oxygen gas will have a final fill pressure of 3000 psig and the settle pressure of 2640 psig 70° F. (21° C.). The first step in the sequence is venting all cylinders by opening vent valves 122 or 164 to a predefined vent pressure set point, typically 1 psig. Once the target vent pressure is acknowledged by the control system the sequence will close the vent valves and proceed to evacuation step of the sequence and evacuate the cylinders to predefined level as defined by the predetermined recipe; vacuum valves 126 or 168 opens and vacuum pumps 128 starts. /

The vacuum system valves 126 and 168 will be as large as possible to process a large volume of fluid and provide a faster vacuum cycle. The vacuum pumps are strategically placed as close to the manifold evacuation valves 126, 168 and fill head 130, 174 as possible using a large pipe diameter connection such as 2.5 inch (6.4 cm) or larger. The length of piping connecting vacuum system valve and vacuum pump is no greater than 4 meters and preferably no greater than 3.3 meters. The vacuum shut-off valves have the greatest single impact on the system operation. The cylinder evacuation process assures filling of cylinders to target purity specification. For example, to fill oxygen cylinders, the mobile system can achieve evacuation of a 20 cylinder pallet to a target vacuum level of 29-inch water column (WC) within 4% to 10%, and preferably less than 6% of the fill time from 29-inch water column (WC) to a settle pressure of 2640 psig.

Once cylinder evacuation is complete, the system will proceed to either a gas purge cycle passivate the cylinders or directly to cylinder gas filling. Precise gas filling proceeds by opening the manifold fill valve 124, 166 controlled by the PLC fi program in combination with a predetermined algorithm to calculate the mass equivalence using pressure sensor 134 and temperature sensor 136, 172 data. A central server will broadcast, through cell or wired communications, standard gas mixture recipe specifications to the PLC. This can occur for all station PLCs simultaneously. The fill process can be monitored in real time with instructions sent to the PLC to modify the fill conditions to the specifications.

Although the invention has been described in detail with reference to a certain preferred embodiment, those skilled in the art will recognize that there are other embodiments of the invention that fall within the spirit and the scope of the attached claims.

What is claimed is:

1. A method of using a compact, mobile filing station comprising:
assembling a filling station system containing filling process equipment for the filling of fluids into a cylinder at a central shop location, the filling station having a self-contained autonomous control system for filling the cylinder with one or more fluids at predetermined fill rates,
mounting the filling station on a mobile skid for shipping to a final location of use using a standard transport vehicle, the skid having a physical configuration conforming to available transport area of the standard transport vehicle and the filing station having the capacity to fill cylinders at an average rate of at least 80 scfh per sq. foot of skid;
shipping the skid from the central shop location to the final location of use on the transport vehicle;
removing the skid from the transport vehicle and connecting the filling station to a source of the one or more fluids;
filling the cylinder with the one or more fluids using the filling station; and
refiling the cylinder using the filling station after the use of the one or more fluids from the cylinder. /

2. The method of claim 1 wherein the filling equipment includes at least one cryogenic reciprocating pump, a vaporizer; a vacuum pump; and a fill head connected by a network of piping and valves for venting, evacuating and filling cylinders on a skid with an area of not more than about 72 ft².

3. The method of claim 1 wherein the filling station has two filling systems mounted on the skid.

4. The method of claim 3 wherein the filling station includes filling equipment to achieve venting, vacuum, purging, and filing of the cylinder.

5. The method of claim 1 wherein the fluid is a cryogenic fluid or mixture of fluids.

6. The method of claim 1 wherein the fluid is selected from oxygen, nitrogen, argon, helium, carbon dioxide, hydrogen, methane, natural gas and mixtures of two or more thereof.

7. The method of claim 1 wherein the skid is made from a welded tubular steel structure and all major filing equipment is affixed to the floor of the skid on solid rubber blocks using a rod and pinion assembly.

8. The method of claim 1 wherein the filling station has a dedicated control system that will fill cylinders in accordance with a predetermined recipe at a predetermined rate of flow.

9. The method of claim 8 wherein the control system collects all filling data and stores such data on a local server which can communicate with a remote receiver and which can receive instruction for filling operations.

10. The method of claim 5 wherein the filling comprises:
pumping the cryogenic fluid or mixture of fluids at an initial rate to an elevated pressure within the range of from 800 to 10,000 psia to produce an elevated pressure cryogenic liquid;
vaporizing a first portion of the elevated pressure cryogenic liquid to produce an elevated pressure gas;
mixing a second portion of the elevated pressure cryogenic liquid with the elevated pressure gas and vaporizing the second portion of the elevated pressure cryogenic liquid by direct heat exchange with the elevated pressure gas to produce a controlled temperature elevated pressure gas having a temperature of higher than −40° F. (−40° C.);
passing the controlled temperature elevated pressure gas into the cylinder to form a filled gas; and
varying the cryogenic liquid pumping initial rate based on the temperature rise to limit the temperature of filled gas to not more than 120° F.

11. The process of claim 10 wherein the first portion of the elevated pressure cryogenic liquid passes through a vaporizer to produce the elevated pressure gas and the second portion of the elevated pressure cryogenic liquid is mixed directly with the elevated pressure gas to form a controlled temperature elevated pressure gas ready for filling into the cylinder.

12. The process of claim 11 wherein and the second portion of the elevated pressure cryogenic liquid is vaporized by direct heat exchange with the elevated pressure gas to produce a temperature of the controlled temperature elevated pressure gas of between −31 oF to 14 oF.

13. The process of claim 12 wherein the controlled temperature elevated pressure gas is passed into the cylinder at a rate of 200 to 1000 psi per minute.

14. The process of claim 13 wherein the final pressure of the gas within the cylinder is within the range of 1000 to 3500 psia and the temperature is within the range of 59 oF to 120 oF.

15. A method of assembling a filling station on a mobile skid for shipment comprising:
obtaining information identifying the filling process equipment needed for the filling station and the dimensions of the skid, the skid having a physical configuration conforming to available transport area of a standard a transport vehicle;
determining a volumetric flow rate per unit area of the skid at which the filling process equipment fills a cylinder with one or more fluids;
determining a configuration of the filling processing equipment on the skid in accordance with the determined volumetric flow rate per unit area of the skid, the determined configuration identifying at least one of (i) the location of the filling process equipment within the skid and (ii) the piping path interconnecting the filling process equipment; and
assembling the filling station based on the determined configuration of the filling processing equipment at a central shop location, the filling station comprising a self-contained autonomous control system and filling process equipment for filling cylinders with one or more fluids;
mounting the filling station on the skid, the skid having a physical configuration conforming to the transport area of a standard transport vehicle; and
loading the skid on the transport vehicle for shipment to the location of use.

16. The method of claim 15 wherein the fluid is selected from oxygen, nitrogen, argon, helium, carbon dioxide, hydrogen, methane, natural gas and mixtures of two or more thereof.

17. The method claim 5 wherein the dimensions of the ski(are not more than about 72 ft2.

18. The method of claim 15 wherein the volumetric flow rate per unit area of the skid is at least 80 scfh per sq. foot of skid.

19. A method of assembling a compact, mobile filling station for shipment to a final location of use comprising:
identifying the filling process equipment needed for the mobile filling station, the filling station comprising a self-contained autonomous control system and filling process equipment for filling a cylinder with the one or more fluids at a predetermined volumetric flow rate,
determining the available transport area of a standard transport vehicle and constructing a transport skid having a physical configuration conforming to the available transport area of a standard a transport vehicle,
determining a volumetric flow rate per unit area of the skid at which the filling process equipment fills the cylinder with the one or more fluids, the volumetric flow rate determined so that the average cylinder fill rate, as measured in volume of fluid per time per unit area, for a standard “T” size cylinder is from 90 scfh/ft2 to 105 scfh/ft2;
determining a configuration of the filling processing equipment on the skid in accordance with the determined volumetric flow rate, the determined configuration including the (i) the location of the filling process equipment on the skid and (ii) the shortest piping path lengths on the skid for connecting the filling process equipment to the cylinder;
assembling the filling station based on the determined configuration of the filling processing equipment at a central shop location,
mounting the filling station on the skid with all major filing process equipment affixed to the floor of the skid; and
loading the skid on the transport vehicle for shipment to the final)cation of use.

20. The method of claim 19 further comprising the steps of:
removing the skid from the transport vehicle and connecting the filling station to a source of the one or more fluids;
filling the cylinder with the one or more fluids using the filling station; and
refiling the cylinder using the filling station after the use of the one or more fluids from the cylinder.
